(19) United States
(12) Patent Application Publication
(10) Pub. No.: US 2023/0412385 A1
(43) Pub. Date: Dec. 21, 2023

(54) REGISTRATION TERMINAL, HOLDER TERMINAL, METHOD, AND PROGRAM

(71) Applicant: NIPPON TELEGRAPH AND TELEPHONE CORPORATION, Tokyo (JP)

(72) Inventors: Shigenori OHASHI, Musashino-shi (JP); Atsushi NAKADAIRA, Musashino-shi (JP); Shigeru FUJIMURA, Musashino-shi (JP); Keita SUZUKI, Musashino-shi (JP)

(73) Assignee: NIPPON TELEGRAPH AND TELEPHONE CORPORATION, Tokyo (JP)

(21) Appl. No.: 18/031,520

(22) PCT Filed: Oct. 14, 2020
(86) PCT No.: PCT/JP2020/038779

§ 371 Date: Apr. 12, 2023

(51) Int. Cl. H04L 9/32

(52) U.S. Cl. CPC H04L 9/3234

(57) ABSTRACT

A registration terminal according to an embodiment is a registration terminal which is connectable to a distributed ledger network, and includes: a token generation unit configured to generate a transaction related to generation of a token to the distributed ledger network and transmit the transaction to the distributed ledger network to generate the token in the distributed ledger network; and a registration unit configured to generate information in which access information to the token is set in a file to be processed, generate an identifier for the file to be processed, generate a transaction related to registration of the identifier to the token, and transmit the transaction to the distributed ledger network to register the identifier in the token.

### TECHNICAL FIELD

Embodiments of the present invention relate to a registration terminal, a holder terminal, a method and a program.

### BACKGROUND ART

In transaction of encrypted currency represented by bitcoin (registered trademark), a blockchain, which is a kind of distributed ledger technology of a non-central collection type, is used. Since a blockchain has high robustness against tampering, its use has been studied for various applications such as smart contracts capable of executing various contracts or transactions in addition to cryptocurrency.

As a programmable blockchain that can handle a smart contract, for example, there is Ethereum that can execute a general-purpose distributed application program.

In the distributed ledger technology that can realize various smart contracts, there is a distributed ledger in which transactions are grouped into blocks. Since such a distributed ledger has a data structure in which blocks are linked by a hash, it is not suitable for managing a file having a large data size.

In the distributed ledger technique, transactions are not collected in the above-mentioned blocks, but there is a distributed ledger expressed by the connection of transactions. However, since such a distributed ledger has a structure in which transactions for the past are left, it is not suitable for the management of the above file.

Regarding a method of distributed file management, there is that of a storage in which files are managed, using a unique identifier (ID) generated from a content hash or the like (for example, see Non Patent Literature 1). Further, there is also a method in which a file is registered in the storage and the ID of the file is managed by being recorded in the distributed ledger (see, for example, Non Patent Literature 2).

### CITATION LIST

### Non Patent Literature

NON PATENT LITERATURE 1: Juan Banet, “IPFS—Content Addressed, Versioned, P2P File System (DRAFT 3)”, [online], [retrieved in Sep. 10, 2020], Internet <URL: https://ipfs.io/ipfs/QmR7GSQM93Cx5eAg6a6yRzNde1FQv7uL6X1o4k 7zrJa3LX/ipfs.draft3.pdf>
NON PATENT LITERATURE 2: Micheal Chan, “Build a simple Ethereum+InterPlanetary File System (IPFS)+React.js DApp.”, [online], [retrieved in Sep. 10, 2020], Internet <URL: https://itnext.io/build-a-simple-ethereum-interplanetary-file-system-ipfs-react-js-dapp-23ff4914ce4e>

### SUMMARY OF THE INVENTION

### Technical Problem

When an identifier of the file is recorded in a distributed ledger, the file can be identified after referring to the distributed ledger, but the information of the corresponding distributed ledger cannot be identified and referred to from the file.

For example, when a hash of a file is recorded on a distributed ledger, a token to be referred to cannot be identified from the file. The same also applies to a case where the hash of the chunk is recorded on the distributed ledger.

The present invention has been made in view of the above circumstances, and an object of the present invention is to provide a registration terminal, a holder terminal, a method and a program capable of referring to information managed by a distributed ledger from a file.

### MEANS FOR SOLVING TO PROBLEM

A registration terminal according to an aspect of the present invention is a registration terminal connectable to a distributed ledger network, and includes a token generation unit configured to generate a transaction related to generation of a token on the distributed ledger network and transmit the transaction to the distributed ledger network to generate the token in the distributed ledger network; and a registration unit configured to generate information in which access information to the token is set in a file to be processed, generate an identifier for the file to be processed, generate a transaction related to registration of the identifier to the token, and transmit the transaction to the distributed ledger network to register the identifier in the token.

A registration terminal according to an embodiment of the present invention is a file holder terminal connectable to a distributed ledger network in which a token including an identifier of a file to be processed is held, in which access information to the token is written in the file to be processed, and the file holder terminal includes an acquisition unit configured to acquire a file identifier from the token, using access information for the token described in the file to be processed, and a determination unit configured to determine that the file identifier of the file to be processed matches the file identifier acquired by the acquisition unit.

A holder terminal according to an aspect of the present invention is a file holder terminal connectable to a distributed ledger network in which a token including a user identifier that is an identifier of an authorized user of a file stored in a storage device is held, in which access information to the token is described in a file stored in the storage device, and the file holder terminal includes an acquisition unit configured to acquire the user identifier from the token, using access information to the token described in the file stored in the storage device, in response to a request related to acquisition of the file stored in the storage device and including an identifier of a user of a request source; and a transmission unit configured to transmit a file stored in the storage device to the request source, when an identifier included in the request matches a user identifier acquired by the acquisition unit.

A registration method according to an aspect of the present invention is a method performed by a registration terminal connectable to a distributed ledger network, the method including: generating a transaction related to generation of a token to the distributed ledger network, and transmitting the transaction to the distributed ledger network to generate the token in the distributed ledger network; and generating information in which access information to the token is set in a file to be processed, generating an identifier of the file to be processed, generating a transaction related to registration of the identifier to the token, and transmitting the transaction to the distributed ledger network to register the identifier in the token.

### Advantageous Effects of the Invention

According to the present invention, information managed by the distributed ledger can be referred to from the file.

### BRIEF DESCRIPTION OF THE DRAWINGS

FIG. 1 is a diagram showing an application example of a management system according to an embodiment of the present invention.

FIG. 2 is a diagram showing an application example of a management system according to an embodiment of the present invention.

FIG. 3 is a block diagram showing an example of a functional configuration of a file registration terminal.

FIG. 4 is a block diagram showing an example of a functional configuration of a file holder terminal.

FIG. 5 is a block diagram showing an example of a functional configuration of a user terminal.

FIG. 6 is a diagram showing an example of information managed by the distributed ledger and information managed by a file used in an embodiment of the present invention.

FIG. 7 is a diagram showing an example of information managed by the distributed ledger and information managed by a file used in an embodiment of the present invention.

FIG. 8 is a diagram showing a sequence for explaining an example of file registration processing for a normal storage.

FIG. 9 is a diagram showing a sequence for explaining an example of file registration processing for a storage in which a file is converted into a DAG.

FIG. 10 is a diagram showing a sequence for explaining an example of file association verification processing to a normal storage.

FIG. 11 is a diagram showing a sequence for explaining an example of file association verification processing for a storage in which a file is converted into a DAG.

FIG. 12 is a diagram showing a sequence for explaining an example of pre-transmission verification processing for a file for a normal storage.

FIG. 13 is a diagram showing a sequence for explaining an example of pre-transmission verification processing of a file for a storage in which the file is DAG.

FIG. 14 is a block diagram showing an example of a hardware configuration of the file registration terminal according to an embodiment of the present invention.

### DESCRIPTION OF EMBODIMENTS

Referring to the drawings, an embodiment according to this invention will be described below.

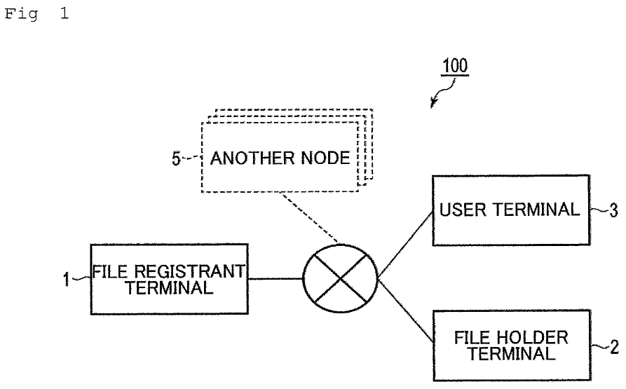

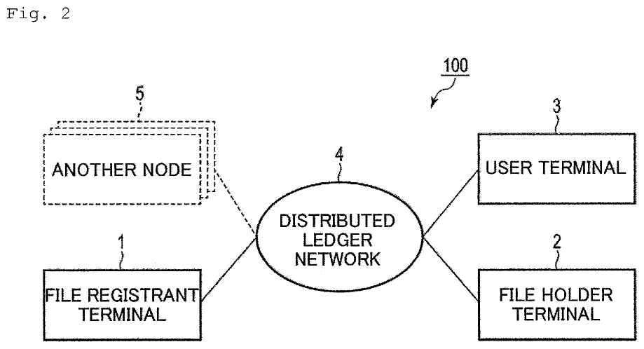

FIGS. 1 and 2 are diagrams showing an application example of a management system according to an embodiment of the present invention. FIG. 1 shows an entire network configuration according to the management system according to the embodiment of the present invention.

As shown in FIG. 1, a management system 100 according to an embodiment of the present invention is a system in which a file registration terminal 1, a file holder terminal 2, and a user terminal 3 can be connected via a network, and each terminal can communicate with the others.

FIG. 2 shows a network configuration of an application program of a distributed ledger according to a management system according to an embodiment of the present invention.

In an example shown in FIG. 2, a management system 100 according to an embodiment of the present invention is a system which includes a file registration terminal 1, a file holder terminal 2, and a user terminal 3, and in which each terminal can communicate with the others.

The file registration terminal 1, the file holder terminal 2, and the user terminal 3 have an access function for the distributed ledger network 4, and a private key associated with each account is under the control of the user, file registrant, and file holder. A place where the secret key is stored is not specified in particular.

The distributed ledger network 4 is made up of a plurality of terminals. The file registration terminal 1, the file holder terminal 2 and the user terminal 3 may have a node function for maintaining the distributed ledger network 4. Further, a terminal for substituting the node function may be provided between the distributed ledger network 4, the file registration terminal 1, the file holder terminal 2, and the user terminal 3.

The node function is a function for verifying and approving transactions in the network, and updating and holding the ledger information (block information and state database or the like).

The file holder terminal 2 or the user terminal 3 has a function of converting a file in a directed acyclic graph (DAG) format into a file in a normal format. The file registration terminal 1 and the file holder terminal 2 may be the same terminal.

In addition to the file registration terminal 1, the file holder terminal 2 and the user terminal 3, a terminal for substituting a node function may exist in the distributed ledger network 4. This terminal is called another node. In the examples shown in FIGS. 1 and 2, another node 5 may exist for maintaining the distributed ledger network 4.

The file registration terminal 1, the file holder terminal 2, and the user terminal 3 do not include a node function when another node 5 for substituting the node function exists. In this embodiment, a case where the file registration terminal 1, the file holder terminal 2 and the user terminal 3 also execute the node function will be described.

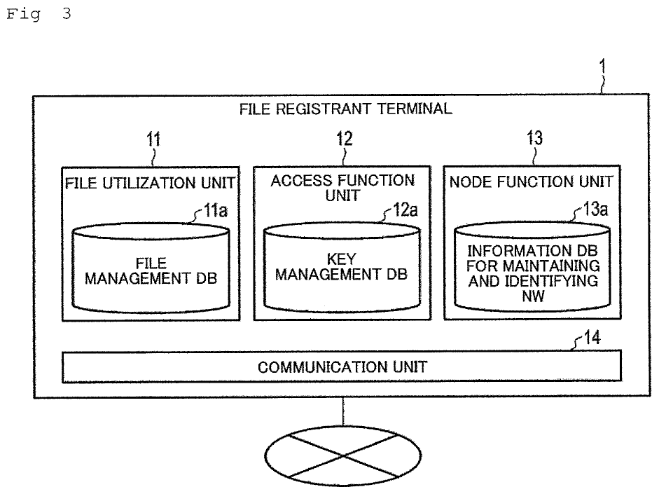

FIG. 3 is a block diagram showing an example of a functional configuration of the file registration terminal. As shown in FIG. 3, the file registration terminal 1 has a file utilization unit 11, an access function unit 12, a node function unit 13, and a communication unit 14. The file utilization unit 11 has a file management database (DB) 11a, the access function unit 12 has a key management DB 12a, and the node function unit 13 has a network (NW) maintenance/identification information DB 13a. Various databases in this embodiment are also referred to as storage.

The file utilization unit 11 manages files, for example, generates, updates, or utilizes the files, and stores the managed data in the file management DB 11a. The file utilization unit 11 also manages keys necessary for file management.

The access function unit 12 issues a transaction to a network and transmits/receives a file to/from another terminal. The access function unit 12 stores information of a key to be used for access in the key management DB 12a.

The node function unit 13 executes the node function, and stores information for network maintenance and identification in processing in a network node (NW) maintenance/identification information DB 13a.

The communication unit 14 is responsible for communication with the outside.

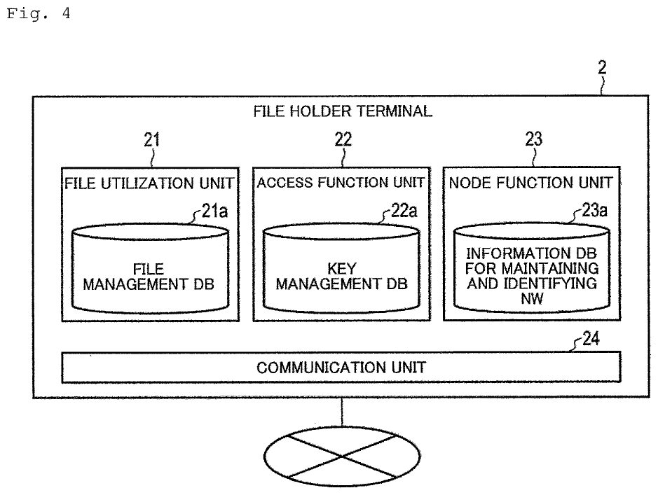

FIG. 4 is a block diagram showing an example of a functional configuration of file holder terminal. As shown in FIG. 4, the file holder terminal 2 includes a file utilization unit 21, an access function unit 22, a node function unit 23, and a communication unit 24.

The file utilization unit 21 has a file management DB 21a, the access function unit 22 has a key management DB 22a, and the node function unit 23 has a network (NW) maintenance/identification information DB 23a.

The file utilization unit 21 performs the same processing as the file utilization unit 11 and stores the data to be managed in the file management DB 21a.

The access function unit 22 performs the same processing as the access function unit 12, and stores the information of the key used for access in the key management DB 22a.

The node function unit 23 executes the node function, and stores the information for network maintenance and identification in a network (NW) maintenance/identification information DB 23a.

The communication unit 24 is responsible for communication with the outside.

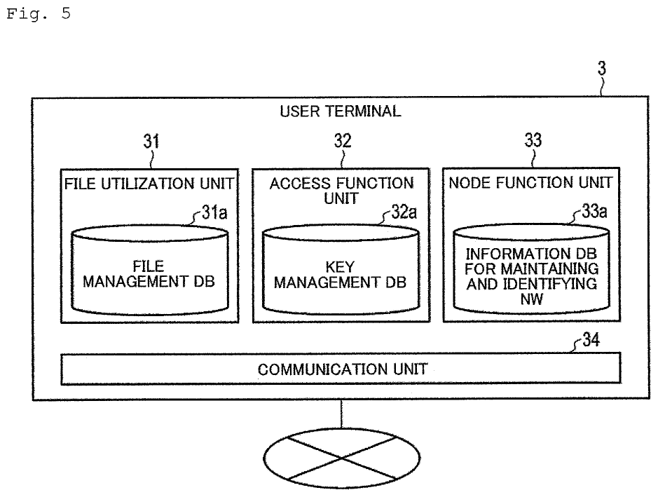

FIG. 5 is a block diagram showing an example of a functional configuration of a user terminal.

As shown in FIG. 5, a user terminal 3 includes a file utilization unit 31, an access function unit 32, a node function unit 33, and a communication unit 34.

The file utilization unit 31 has a file management DB 31a, the access function unit 32 has a key management DB 32a, and the node function unit 33 has a network (NW) maintenance/identification information DB 33a.

The file utilization unit 31 performs the same processing as the file utilization unit 11 and stores the data to be managed in the file management DB 31a.

The access function unit 32 performs the same processing as the access function unit 12, and stores the information of the key used for access in the key management DB 32a.

The node function unit 33 executes the node function, and stores network maintenance/identification information in the network (NW) maintenance/identification information DB 33a.

The communication unit 34 is responsible for communication with the outside.

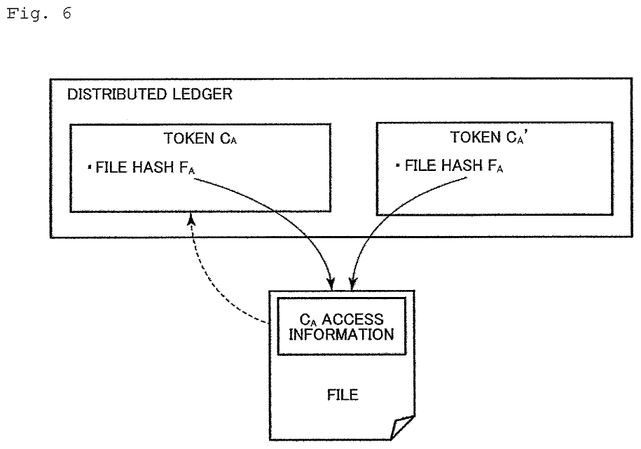

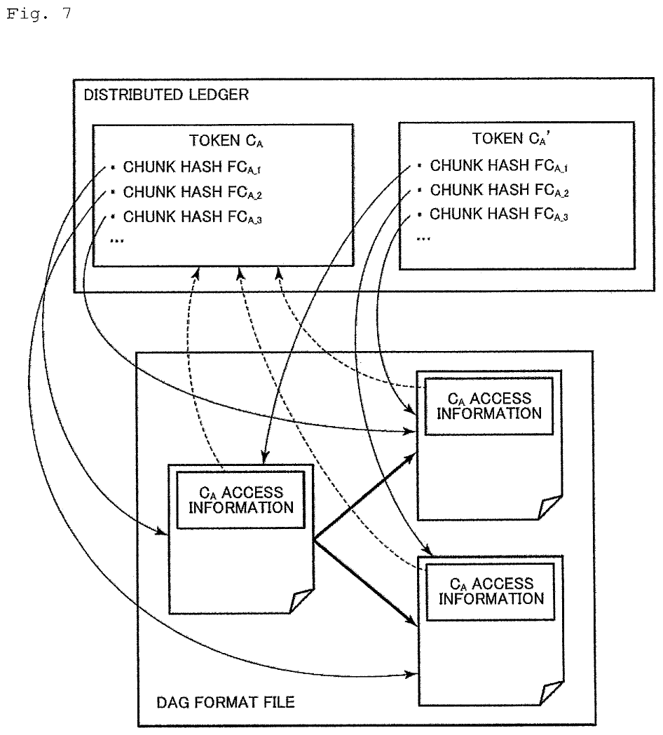

FIGS. 6 and 7 are diagrams showing examples of information managed by the distributed ledger and information managed by the file used in an embodiment of the present invention.

In the example shown in FIG. 6, in the distributed ledger, a token CA and a token CA′ are managed, and a file hash FA, which is a file identifier, is managed in each token.

In this embodiment, access information to the token CA is embedded in the header of each file.

In this embodiment, by recording ID of the file (identifier created from the hash) in the token, a relationship between the correct token and the file can be confirmed.

For example, by utilizing the access information to the token CA, it is possible to access the identifier in the token CA from the file in which this access information is embedded, and it can be confirmed that the token CA is the correct token. On the other hand, the identifier in the token CA′ cannot be accessed from the file in which the access information to the token CA is embedded. From this, it can be confirmed that the token CA′ is not the correct token.

The access information to the token is not limited to the example embedded in the header of the file as described above. For example, after a folder structure is generated in the file, and access information to the token is included in this folder structure, for example, by performing archiving or compression processing by a tar method or a zip method, a file including the access information to the token may be generated.

In the example shown in FIG. 7, in the distributed ledger, the token CA and the token CA′ are managed, and in each token, a plurality of chunk hashes including chunk hash FCA_1, chunk hash FCA_2, and chunk hash FCA_3 which are chunk identifiers are managed.

In the example shown in FIG. 7, access information to the token CA is embedded in each chunk, and a file of a DAG format is formed by the chunks in which the access information is embedded in this way.

In this embodiment, a correct relationship between the token and the chunk can be confirmed by recording the ID of the chunk (the identifier created from hash) in the token.

A storage in which a file is converted into a DAG is, for example, an InterPlanetary File System (IPFS). In the example of the IPFS, access information is stored at a head of the data item of each IPFS object in a manner distinguished from the chunk information of the file body.

<Registration of File: Normal Storage>

Next, a process of registering the file in the normal storage in the management system according to the present embodiment will be described. This registration processing is a process in which an identifier related to a file to be processed is registered in a token on the distributed ledger network. In this embodiment, the storage used in each terminal is divided into a normal storage and a storage in which a file is converted into a DAG. The normal storage is a storage in which a file is not converted into DAG.

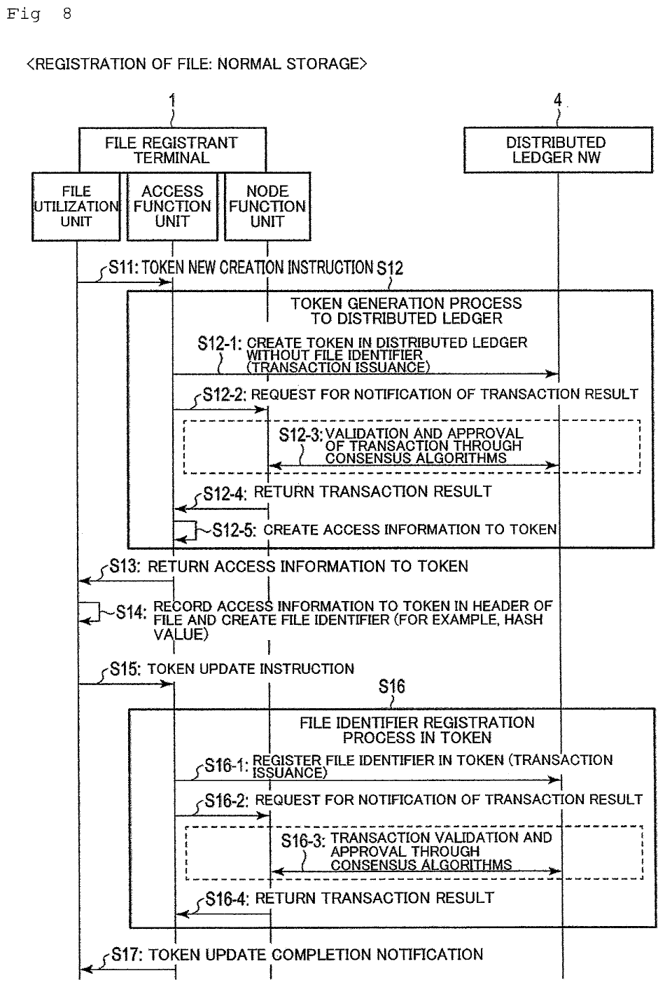

FIG. 8 is a diagram showing a sequence for explaining an example of file registration processing for a normal storage.

(1) The file utilization unit 11 of the file registration terminal 1 instructs an access function unit 12 to generate a Token to a distributed ledger, which is a token related to a file to be processed and stored in the file management DB 11a (S11). In response to the instruction, the access function unit 12 of the file registration terminal 1 performs Token generation processing to the distributed ledger (S12).

Specifically, the access function unit 12 creates a transaction for generating a Token to the distributed ledger without including the file identifier, and broadcasts the transaction to the distributed ledger network 4 via the communication unit 14 (S12-1). The access function unit 12 sends a notification request of a transaction result to the node function unit 13 (S12-2).

Next, in response to a request from the node function unit 13, the transaction is verified by the consensus algorithm, in the distributed ledger network 4. If the transaction satisfies a predetermined requirement, the transaction is confirmed (S12-3).

When the node function unit 13 receives the result of the transaction from the distributed ledger network 4 through the communication unit 14, the node function unit 13 returns the result to the access function unit 12 (S12-4). In response to the result, the access function unit 12 creates “access information to Token” to a file to be processed (S12-5). The processing of step S12 is completed.

The access function unit 12 returns the created “access information to the Token” to the file utilization unit 11 (S13).

(2) The file utilization unit 11 records “access information to the Token” returned in S13 in a header of a file to be processed (which may be referred to as a file header) which is stored in the file management DB 11a. In this case, a plurality of pieces of “access information to the Token” may be recorded in the file header.

(3) The file utilization unit 11 generates a file identifier (for example, a hash) of a file in which access information to the Token is recorded in the file header (S14). In the S14, the file is transmitted to the file holder terminal 2, and an identifier used also for file acquisition may be generated by the file holder terminal 2.

Also, in the above-mentioned (2) and (3), the file utilization unit 11 may record the “access information to the Token” returned in S13 in an access information file different from the file to be processed, store the file to be processed and the access information file stored in the file management DB 11a in the same folder, archive or compress the folder to create a file, and generate the file identifier of the file.

(4) The file utilization unit 11 sends an instruction to update the Token, in this case, to register the file identifier to the Token to the access function unit 12 (S15). In response to the instruction, the access function unit 12 performs file identifier registration processing to the Token related to the “access information to the Token” managed by the distributed ledger (S16).

Specifically, the access function unit 12 creates a transaction for registering a file identifier in a Token managed by the distributed ledger network 4, and broadcasts the transaction to the distributed ledger network 4 via the communication unit 14 (S16-1). The access function unit 12 sends a notification request of a transaction result to the node function unit 13 (S16-2).

Then, the transaction is verified by the consensus algorithm in the distributed ledger network 4 by a request from the node function unit 13. If the transaction satisfies a predetermined requirement, the transaction is confirmed (S16-3).

When the node function unit 13 receives the result of the transaction from the distributed ledger network 4 via the communication unit 14, the node function unit 13 returns the result to the access function unit 12 (S16-4). Thus, the file identifier is recorded in the Token by S16.

In response to the result, the access function unit 12 notifies the file utilization unit 11 of the update completion notification of the Token (S17).

<Registration of Files (Chunks): Storage (IPFS, Etc.) in which Files are Converted into DAG>

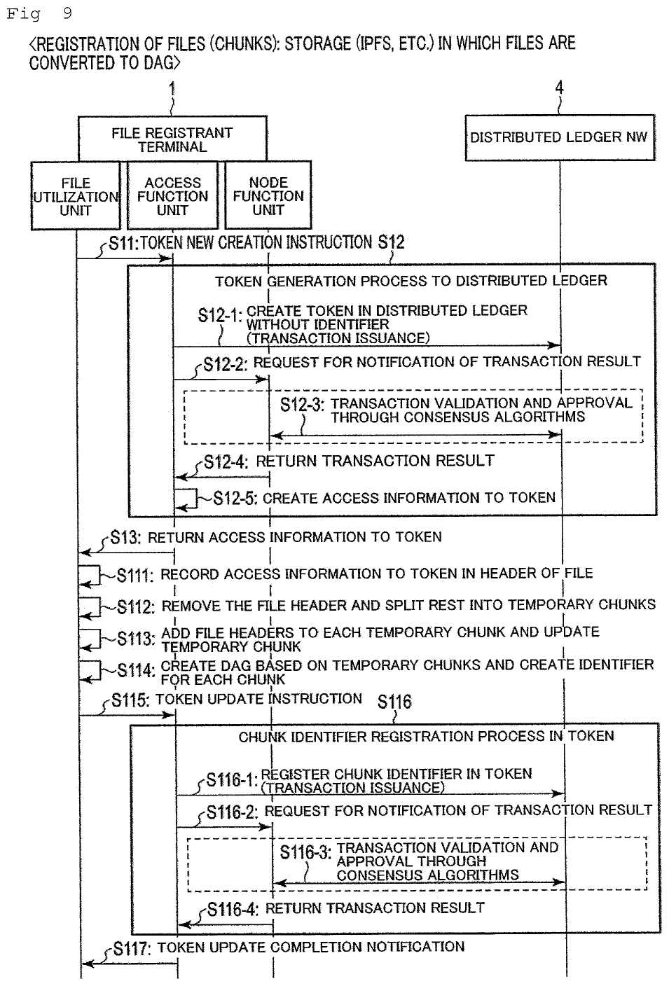

Next, a process of registering a file in a storage in which the file is converted into a DAG in the management system according to the present embodiment will be described. FIG. 9 is a diagram showing a sequence for explaining an example of file registration processing for a storage in which a file is converted into a DAG.

(1) First, the access function unit 12 is instructed to generate a Token to the distributed ledger as described in S11, similarly to the registration processing of the file to the normal storage. Then, as described in S12, the Token generation processing to the distributed ledger is performed.

Next, as described in S13, the created “access information to the Token” is returned to the file utilization unit 11.

(2) The file utilization unit 11 records “access information to Token” in a header of a file to be processed (S111). In this case, a plurality of “access information to the Token” may be recorded.

(3) The file utilization unit 11 removes the header of the file and divides the remaining part into temporary chunks (S112).

(4) The file utilization unit 11 updates the temporary chunk by adding the header of the file to each temporary chunk (S113).

Further, these (2), (3), and (4) may be replaced with the following (2a), (3a), and (4a).

(2a) The file utilization unit 11 records the “access information to the Token” returned in S13 in an access information file, stores the file to be processed and the access information file stored in the file management DB 11a in the same folder, and archives or compresses the folder to create the file.

(3a) The file utilization unit 11 restores the archived or compressed file to the original folder, removes the access information file stored in the folder, and divides the remaining part into temporary chunks.

(4a) The file utilization unit 11 updates the temporary chunk, by adding access information to the Token recorded in an access information file stored in the folder to each temporary chunk (S113).

(5) After (4) or (4a), the file utilization unit 11 creates a file converted into a DAG based on the temporary chunk, and generates an identifier of each chunk forming the file converted into the DAG (S114).

In the above-mentioned (2) to (5), the file utilization unit 11 may record “access information to Token” returned in S13 in the access information file, store the temporary chunk and the access information file in the same folder for each of the temporary chunks, generate a file in which the folder is archived or compressed, create a file converted into DAG based on the file, and generate an identifier of each chunk forming the file converted into DAG.

(6) The file utilization unit 11 sends an instruction to update the Token, in this case, register the chunk identifier to the Token, to the access function unit 12 (S115). In response to this instruction, the access function unit 12 performs chunk identifier registration processing to the Token related to the “access information to the Token” managed by the distributed ledger (S116).

Specifically, the access function unit 12 creates a transaction for registering a chunk identifier in a Token managed by the distributed ledger network 4, and broadcasts the transaction to the distributed ledger network 4 via the communication unit 14 (S116-1). The access function unit 12 sends a notification request of a transaction result to the node function unit 13 (S116-2).

Then, the transaction is verified by consensus algorithm in the distributed ledger network 4 by a request from the node function unit 13. If the transaction satisfies a predetermined requirement, the transaction is confirmed (S116-3).

When the node function unit 13 receives the result of the transaction from the distributed ledger network 4 via the communication unit 14, the node function unit 13 returns the result to the access function unit 12 (S116-4). Thus, the chunk identifier is recorded in the Token by S116.

In response to the result, the access function unit 12 notifies the file utilization unit 11 of the update completion notification of the Token (S117).

Normally, since the entire file including the header is divided into chunks, a chunk not including header information is generated.

On the other hand, in the present embodiment, as described above, in the division into chunks when the file is converted into a file converted into a DAG, a header including at least access information to the Token is added to each chunk.

<Association Verification of File: Normal Storage>

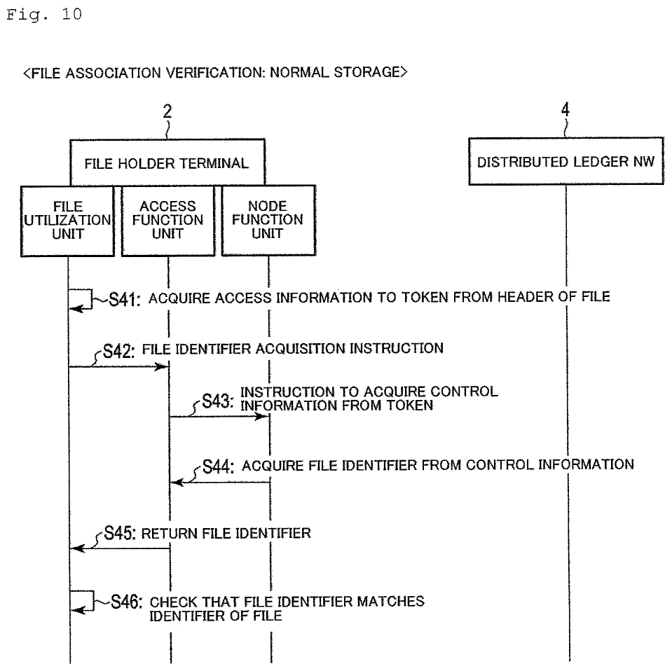

Next, description will be given of a file association verification process with respect to a normal storage in the management system according to the present embodiment. The association verification processing is processing in which, when it is confirmed whether an identifier related to an updated file matches an identifier related to a file before update which is created before the update of the file and managed by the distributed ledger network, and the association between the token managed by the distributed ledger network 4 and the file having access information to the token managed by the file holder terminal 2 is verified. FIG. 10 is a diagram showing a sequence for explaining an example of file association verification processing for a normal storage.

(1) The file utilization unit 21 of the file holder terminal 2 acquires “access information to Token” described in a file header of an updated file to be processed (S41), and instructs an access function unit 22 to acquire a file identifier in the control information in tokens managed by the distributed ledger network 4, using the access information (S42).

When the file to be processed is a file which is archived or compressed together with the access information file, in S41 and S42, the file utilization unit 21 restores the archived or compressed file to an original folder, acquires an access information file stored in the folder, and instructs an access function unit 22 to acquire a file identifier in control information in a token managed by the distributed ledger network 4, using “access information to a Token” recorded in the access information file.

In response to the instruction, the access function unit 22 instructs the node function unit 23 to acquire control information from the token (S43).

In response to the instruction, the node function unit 23 accesses the distributed ledger network 4 via the communication unit 24 to acquire control information from a token related to the “access information to the Token” managed by the distributed ledger, acquires a file identifier from the control information, and returns the file identifier to the access function unit 22 (S44). The access function unit 22 returns the file identifier to the file utilization unit 21 (S45).

(2) The file identifier of the updated file to be processed is stored in the file management DB 21a and managed. The file utilization unit 21 acquires a file identifier of an updated file to be processed from the file management DB 21a, compares the file identifier with the file identifier returned in S45, and checks (verifies) that they match each other (S46).

When the file to be processed is the file archived or compressed, in S46, the file utilization unit 21 restores the file to be processed to an original folder, acquires a file identifier of an updated file to be processed stored in the folder from the file management DB 21a, compares the file identifier with the file identifier returned in S45, and checks (verifies) that they match each other.

When a plurality of “access information to the Token” are held in the file to be processed, association between the identifier of the file to be processed and the file identifiers in the plurality of Tokens is verified.

<Association Verification of File (Chunk): Storage on which Files are Converted to DAG>

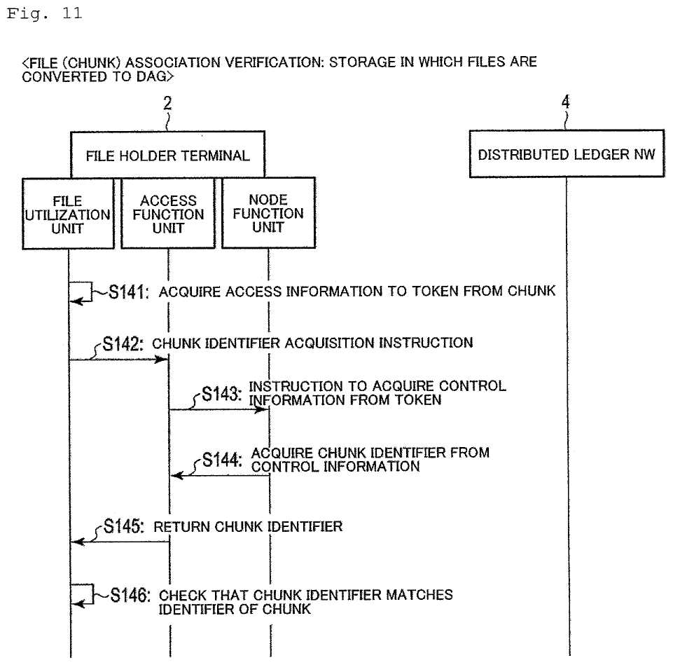

Next, description will be given of a file association verification process with respect to a storage in which a file is converted into a DAG in the management system according to the present embodiment. FIG. 11 is a diagram showing a sequence for explaining an example of a file association verification process for a storage in which a file is converted into a DAG.

(1) The file utilization unit 21 of the file holder terminal 2 acquires “access information to Token” described in a chunk of a file to be processed (S141), and instructs the access function unit 22 to acquire control information, using the access information (S142). In response to the instruction, the access function unit 22 instructs the node function unit 23 to acquire the control information from the token (S143).

When the chunk of the file to be processed is a chunk of a file archived or compressed together with the access information file, in S141 and S142, the file utilization unit 21 restores the archived or compressed file to an original folder, acquires an access information file stored in the folder, and instructs the access function unit 22 to acquire a file identifier in control information in a token managed by the distributed ledger network 4, using “access information to a Token” recorded in the access information file.

In response to the instruction, the node function unit 23 accesses the distributed ledger network 4 via the communication unit 24 to acquire control information from a token related to the “access information to the Token” managed by the distributed ledger, acquires an identifier of a chunk from the control information, and returns the identifier of the chunk to the access function unit 22 (S144). The access function unit 22 returns the identifier of the chunk to the file utilization unit 21 (S145).

(2) The chunk identifier of the chunk of the updated file, to be processed, is stored in the file management DB 21a and managed. The file utilization unit 21 acquires a chunk identifier of a chunk of an updated file being a processing object from the file management DB 21a, compares the chunk identifier with the identifier of the chunk returned in S145 and described in the control information, and checks (verifies) that they match each other (S146).

When the chunk of the file to be processed is the chunk of the file which is archived or compressed, in S146, the file utilization unit 21 restores the file to be processed to an original folder, specifies a chunk of an updated file stored in the folder to be processed, acquires a chunk identifier of the chunk from the file management DB 21a, compares the chunk identifier with the chunk identifier returned in S145, and checks (verifies) that they match each other.

When a plurality of “access information to the Token” are held in the chunk of the file to be processed, association between the identifier of the chunk of the file to be processed and the identifiers of the chunks in the plurality of Tokens is verified.

In the present embodiment, even in a state in which the data to be requested is a normal file or a file converted into a DAG, since the file header or each chunk includes access information to the Token, the validity of the file or the chunk can be verified even if the Token is separated for each file or the chunk.

<Verification Before Sending File: Normal Storage>

Next, a pre-transmission verification processing of file for the normal storage in the management system according to the present embodiment will be described.

The pre-transmission verification processing is a processing for verifying whether when the acquisition of the file or the chunk held in the storage of the file holder terminal 2 is requested from the user terminal 3, the file or the like can be transmitted to the user terminal 3 in response to the request.

In order to execute the pre-transmission verification processing, an identifier such as a file held by the file holder terminal 2 and a user identifier which is an identifier of a user permitted to acquire the file or the like are managed in a token managed on the distributed ledger network 4.

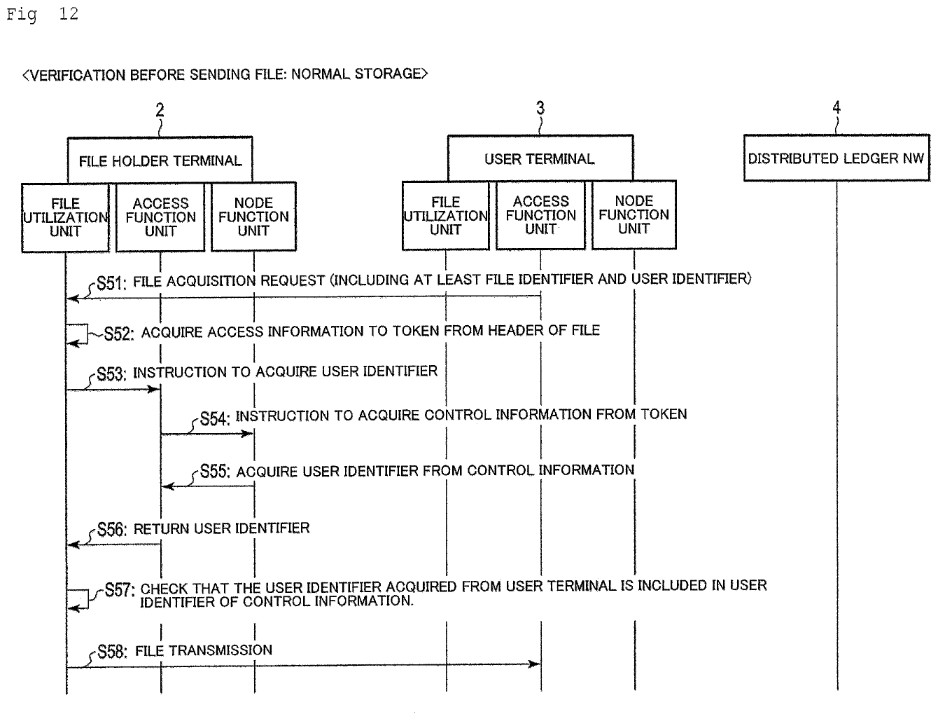

FIG. 12 is a diagram showing a sequence for explaining an example of file association verification processing for a normal storage.

(1) First, the access function unit 32 of the user terminal 3 transmits a request for file acquisition to the file holder terminal 2 via the communication unit 34 according to an operation by the user. The request includes at least a file identifier of a file to be requested, and a user identifier given to a user of the user terminal 3. The file utilization unit 21 of the file holder terminal 2 receives a request for file acquisition from the user via the communication unit 24 (S51).

(2) The file utilization unit 21 of the file holder terminal 2 specifies a file designated to be acquired by the request received in S51 from the file stored in the file management DB 21a, acquires “access information to Token” described in a file header of the file (S52), and instructs the access function unit 22 to acquire a user identifier, using the access information (S53). In response to the instruction, the access function unit 22 instructs the node function unit 23 to acquire control information from the token (S54).

When the file to be processed is a file that is archived or compressed together with the access information file, in S52 and S53, the file utilization unit 21 restores the archived or compressed file stored in the file management DB 21a to the original folder, acquires access information file stored in the folder, and instructs the access function unit 22 to acquire the user identifier, using the “access information to the Token” recorded in the access information file.

In response to the instruction, the node function unit 23 acquires control information from a token managed by the distributed ledger network 4, acquires a user identifier from the control information, and returns the user identifier to the access function unit 22 (S55). The access function unit 22 returns the user identifier to the file utilization unit 21 (S56). When a plurality of Token are described in the access information, control information of the plurality of Token is acquired.

(3) The file utilization unit 21 compares the user identifier returned in S56 with the user identifier included in the request from the user terminal 3, and checks (verifies) that the identifiers match each other, that is, the user identifier included in the request is a request from the user permitted to acquire the held file (S57).

When they match each other, the file utilization unit 21 transmits the file designated by the request to the user terminal 3 via the communication unit 24. The access function unit 32 of the user terminal 3 acquires the transmitted file via the communication unit 34 (S58).

<Pre-Transmission Verification of File (Chunk): Storage in which Files are Converted to DAG>

Next, a description will be given of the pre-transmission verification process of a file for a storage in which the file is converted into a DAG in the management system according to the present embodiment. FIG. 12 is a diagram showing a sequence for explaining an example of the pre-transmission verification process of a file for a storage in which the file is converted into a DAG.

(1) First, the access function unit 32 of the user terminal 3 transmits a request for acquiring a chunk to the file holder terminal 2 via the communication unit 34 according to an operation by the user. The request includes at least a chunk identifier of a chunk of a file to be requested and a user identifier given to a user of the user terminal 3. The file utilization unit 21 of the file holder terminal 2 receives a request for chunk acquisition from a user via the communication unit 24 (S151).

(2) The file utilization unit 21 specifies a chunk designated to be acquired by the request received in S51 from the chunk of the file stored in the file management DB 21a, acquires “access information to the Token” described in the chunk (S152), and instructs the access function unit 22 to acquire the user identifier, using the access information (S153). In response to the instruction, the access function unit 22 instructs the node function unit 23 to acquire the control information from the token (S154).

When the chunk of the file to be processed is a chunk of a file archived or compressed together with the access information file, in S152 and S53, the file utilization unit 21 restores the archived or compressed file stored in the file management DB 21a to an original folder, then, specifies a chunk designated to be acquired by a request received in S151 from a chunk stored in the folder, acquires “access information to a Token” recorded in an access information file stored in the folder together with the chunk, and instructs the access function unit 22 to acquire a user identifier, using the access information.

In response to the instruction, the node function unit 23 acquires control information from a token managed by the distributed ledger network 4, acquires a user identifier from the control information, and returns the user identifier to the access function unit 22 (S155). The access function unit 22 returns the user identifier to the file utilization unit 21 (S156). When a plurality of Token are described in the access information, control information of the plurality of Token is acquired.

(3) The file utilization unit 21 compares the user identifier returned in S56 with the user identifier included in the request from the user terminal 3, and checks (verifies) that these identifiers match, that is, the user identifier included in the request is a request from a user who is permitted to acquire the above-mentioned retained file (S157).

When they match, the file utilization unit 21 transmits the chunk designated by the request to the user terminal 3 via the communication unit 24. The access function unit 32 of the user terminal 3 acquires the transmitted chunk via the communication unit 34 (S158).

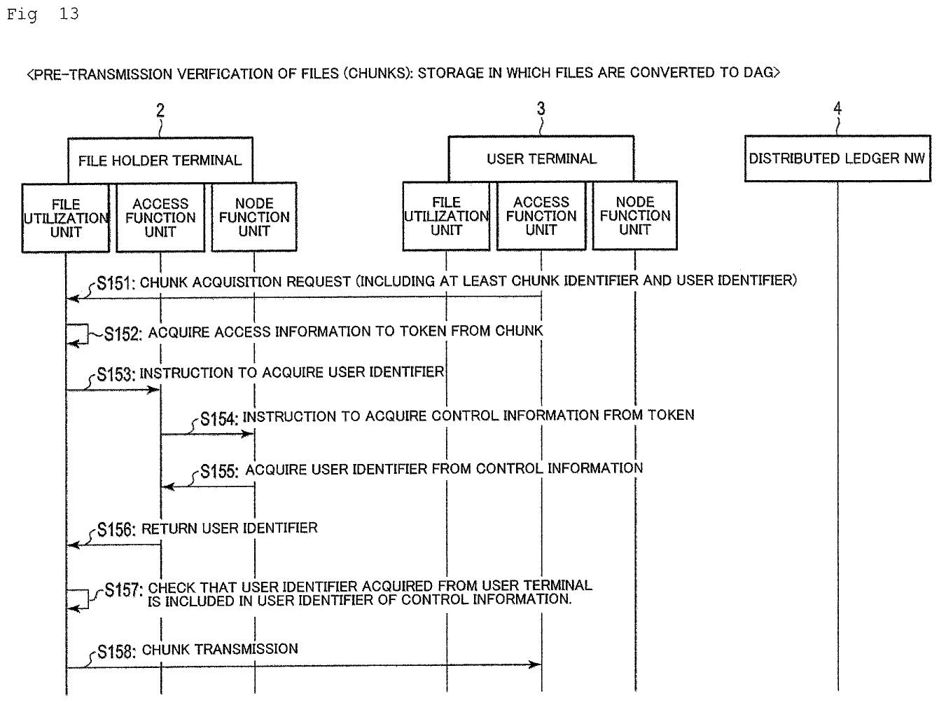

As shown in FIGS. 12 and 13, in the present embodiment, even a state of data to be requested is a normal file state or a state of a file converted into a DAG, since the file header or each chunk includes access information to the Token, it is possible to control sharing of the file or chunk even if the Token is different for each file or chunk.

<Conversion Process from DAG File to Normal File>

When a normal file is acquired from a storage in which the file is converted into a DAG, the conversion from the file in the DAG format to the normal file is performed by the following processing. This conversion is performed before the file holder terminal 2 is used by the user terminal 3 or before the file holder terminal 2 is transmitted to the user terminal 3.

(1) All chunks that form the DAG are acquired.

(2) The fragment of the file body and the file header are obtained from the chunk.

(3) It is confirmed that all file headers obtained from all chunks are the same.

When the file to be processed is a file which is archived or compressed including the access information file, the fragment of the file body and the access information file in the file may be acquired from the chunk in (2) and (3), and it may be confirmed that all the access information files acquired from all the chunks are the same.

(4) The fragments of the file body are joined together, and a file header is given.

(5) If necessary, the processing of the above-mentioned <association verification of the file: normal storage> is executed.

As described above, in the management system according to an embodiment of the present invention, since the file to be processed includes the access information to the token on the distributed ledger and the identifier of the file is included in the token, the information managed in the distributed ledger can be referred to from the file.

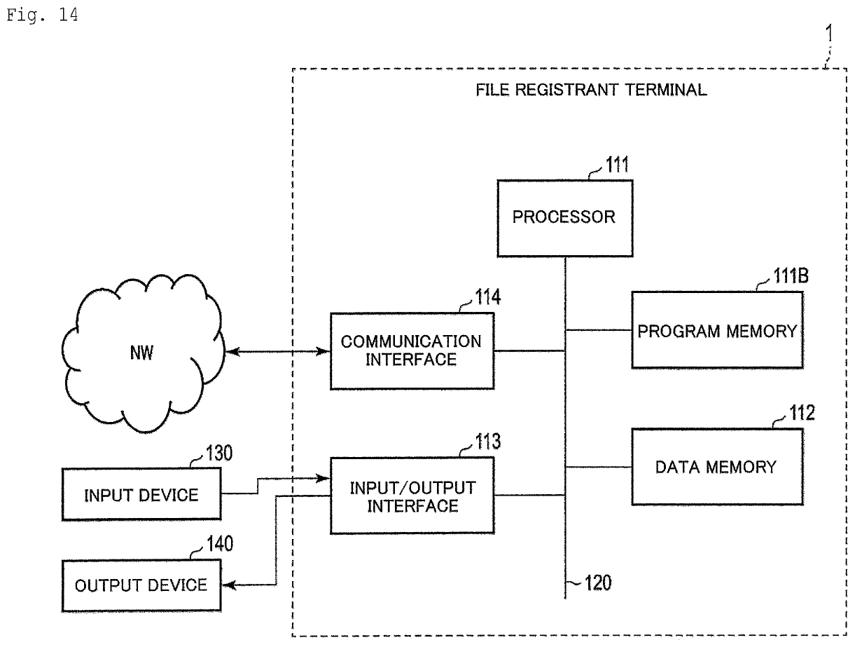

FIG. 14 is a block diagram showing an example of hardware configuration of a file registration terminal according to an embodiment of the present invention. In the example shown in FIG. 14, the file registration terminal 1 is made up of, for example, a server computer or a personal computer, and has a hardware processor 111, such as a central processing unit (CPU). Further, a program memory 111B, a data memory 112, an input/output interface 113, and a communication interface 114 are connected to the hardware processor 111 via a bus 120. The same also applies to the file holder terminal 2 and the user terminal 3.

The communication interface 114 includes, for example, one or more wireless communication interface units, and can exchange information with a communication network NW. As the wireless interface, an interface which adopts a low power wireless data communication standard such as a wireless local area network wireless (LAN) can be used.

An input device 130 and an output device 140 for an operator attached to the file registration terminal 1 are connected to the input/output interface 113. The input/output interface 113 performs processing which captures operation data input by an operator through the input device 130 such as a keyboard, a touch panel, a touchpad, or a mouse, and outputs the output data to the output device 140 that includes a liquid crystal or organic electro-luminescence (EL) display device or the like to display. The input device 130 and the output device 140 may be replaced by devices included in the file registration terminal 1 or an input device and an output device of other information terminals capable of communicating with the file registration terminal 1 via the communication network NW may be used.

In the program memory 111B, as a non-transitory substantial storage medium, for example, a non-volatile memory such as a hard disk drive (HDD) or a solid state drive (SSD) capable of performing the writing and reading of information as occasion demands, and a non-volatile memory such as a read only memory (ROM) are used in combination, and a program necessary for performing various control processing according to an embodiment is stored.

As a tangible storage medium, a combination of the aforementioned non-volatile memory and a volatile memory such as a Random Access Memory (RAM) is used, and the data memory 112 is used to store various data acquired and created in the process of performing various processes.

The file registration terminal 1 according to an embodiment of the present invention can be configured as a data processing device that includes, as processing function units that are realized by software, the file utilization unit 11, the access function unit 12, the node function unit 13, the communication unit 14, which are shown in FIG. 3.

Further, the various databases shown in FIG. 3 may be configured using the data memory 112 shown in FIG. 12. However, the above-mentioned various databases are not indispensable in the file registration terminal 1, and may be provided, for example, in an external storage medium such as a universal serial bus (USB) memory or in a storage device such as a database server disposed in the cloud.

The processing function units in each part of the file utilization unit 11, the access function unit 12, the node function unit 13, and the communication unit 14 shown in FIG. 3 can be realized by reading the program stored in the program memory 111B by the hardware processor 111 and executing the program. A part or all of these processing function units may be realized by other various forms including an integrated circuit such as an application specific integrated circuit (ASIC) or a field-programmable gate array (FPGA).

Also, the techniques described in the embodiments is a program (software means) that can be executed by a computer, which can be stored on a recording medium such as a magnetic disk (floppy (registered trademark) disk, hard disk, etc.) or an optical disk (CD-ROM, DVD, MO, etc.), or a semiconductor memory (ROM, RAM, flash memory, etc.), and can be transmitted and distributed by a communication medium. A computer that realizes this device reads a program recorded on a recording medium, constructs a software means by a setting program in some cases, and executes the above-described processing by operations being controlled by the software means. Note that the recording medium mentioned in the present description is not limited to a recording medium for distribution, and includes a storage medium provided in the computer or in a device connected thereto through a network, such as a magnetic disk or a semiconductor memory.

Note that the present invention is not limited to the embodiments described above and can variously be modified at an execution stage within a scope not departing from the gist thereof. In addition, embodiments may be combined as appropriate, and in such a case, combined effects can be achieved. In addition, the embodiments described above include various aspects of the invention, and the various aspects of the invention can be extracted by combinations selected from a plurality of disclosed constituent elements. For example, even when some of all the constituent elements disclosed in the embodiments are deleted, as long as the problems can be solved and the effects can be obtained, a configuration from which the constituent elements are deleted can be extracted as an aspect of the invention.

### REFERENCE SIGNS LIST

1 File registration terminal
2 File holder terminal
3 User terminal
4 Distributed ledger network
11, 21, 31 File utilization unit
12, 22, 32 Access function unit
13, 23, 33 Node function unit
14, 24, 34 Communication unit
100 Management system

1. A registration terminal which is connectable to a distributed ledger network, the registration terminal comprising:
one or more processors; and
a storage medium having computer program instructions stored therein that, when executed by the one or more processors, perform to:
generate a transaction related to generation of a token to the distributed ledger network;
transmit the transaction to the distributed ledger network to generate the token in the distributed ledger network; and
generate information in which access information to the token is set in a file to be processed;
generate an identifier for the file to be processed;
generate a transaction related to registration of the identifier to the token; and
transmit the transaction to the distributed ledger network to register the identifier in the token.

2. The registration terminal according to claim 1, wherein the instructions, when executed by the one or more processors, perform to
generate information in which access information to the token is set in the file to be processed;
remove a file header from the file to be processed and which divides the file into temporary chunks;
add the file header to each of the temporary chunks;
create a directed acyclic graph file using each temporary chunk;
create an identifier of the temporary chunk constituting the created file to the token;
create a transaction related to registration of the identifier; and
transmit the transaction to the distributed ledger network to register the identifier in the token.

3. A file holder terminal which is connectable to a distributed ledger network in which a token including an identifier of a file to be processed is held,
wherein access information to the token is described in the file to be processed,
the file holder terminal comprising:
one or more processors; and
a storage medium having computer program instructions stored therein that, when executed by the one or more processors, perform to:
acquire a file identifier from the token, using access information to the token described in the file to be processed, and
determine that the file identifier of the file to be processed matches the file identifier acquired.

4. The file holder terminal according to claim 3,
wherein the instructions, when executed by the one or more processors, perform to:
acquire the identifier from the token, using access information to the token described in a chunk of the file to be processed, and
determine that the identifier of the chunk of the file to be processed matches the identifier.

5. A file holder terminal which is connectable to a distributed ledger network in which a token including a user identifier that is an identifier of an authorized user of a file stored in a storage device is held,
wherein access information to the token is described in a file stored in the storage device,
the file holder terminal comprising:
one or more processors; and
a storage medium having computer program instructions stored therein that, when executed by the one or more processors, perform to:
acquire the user identifier from the token, using access information to the token described in the file stored in the storage device, in response to a request related to acquisition of the file stored in the storage device and including an identifier of a user of a request source; and
transmit a file stored in the storage device to the request source, when an identifier included in the request matches a user identifier acquired.

6. The file holder terminal according to claim 5, which is connectable to a distributed ledger network in which a token including a user identifier that is an identifier of an authorized user of a chunk of a file stored in the storage device is held,
wherein access information to the token is described in a chunk stored in the storage device,
wherein the instructions, when executed by the one or more processors, perform to:
acquire the user identifier from the token, using access information to the token described in the chunk stored in the storage device, in response to a request related to acquisition of the chunk stored in the storage device and including an identifier of a user of a request source, and
transmit the chunk stored in the storage device to the request source, when the identifier included in the request matches the user identifier acquired.

7. A method performed by a registration terminal connectable to a distributed ledger network, the method comprising:
generating a transaction related to generation of a token to the distributed ledger network;
transmitting the transaction to the distributed ledger network to generate the token in the distributed ledger network; and
generating information in which access information to the token is set in a file to be processed;
generating an identifier of the file to be processed;
generating a transaction related to registration of the identifier to the token; and
transmitting the transaction to the distributed ledger network to register the identifier in the token.

8. A non transitory computer readable storage medium storing the program according to claim 1.

9. A non transitory computer readable storage medium storing the program according to claim 3.

10. A non transitory computer readable storage medium storing the program according to claim 5.
